(19) United States
(12) Patent Application Publication
(10) Pub. No.: US 2009/0135283 A1
(43) Pub. Date: May 28, 2009

(54) PIXEL ARRAY STRUCTURE FOR CMOS IMAGE SENSOR AND METHOD OF THE SAME

(75) Inventor: Do Young LEE, Seongnam-si (KR)

Correspondence Address: CANTOR COLBURN, LLP, 20 Church Street, 22nd Floor, Hartford, CT, 06103, US

(73) Assignee: SILICONFILE TECHNOLOGIES INC., Seoul (KR)

(21) Appl. No.: 12/281,571

(22) PCT Filed: Mar. 14, 2007
(86) PCT No.: PCT/KR2007/001241

§ 371 Date: Sep. 3, 2008

(30) Foreign Application Priority Data
Mar. 14, 2006 (KR) 10-2006-0023685

(51) Int. Cl. H04N 5/335

(52) U.S. Cl. 348/294; 348/E05.091

(57) ABSTRACT

Provided is a pixel array structure and of a complementary metal-oxide-semiconductor (CMOS) image sensor and a method of arranging the same in which unit pixels are arranged diagonally to adjacent unit pixels in a row and column direction. For the arrangement, a pixel array in even rows is shifted to a half of a pitch in a column direction with respect to a pixel array in odd rows.

Accordingly, in a pixel array implemented in a diagonal pattern, a distance between optical sensing elements can be larger, so that optical sensing elements with larger regions can be obtained. In addition, pixel transistor circuit units constructed with MOS transistors can be arranged between the optical sensing elements, so that a photo sensitivity and a resolution can be markedly increased.

### BACKGROUND OF THE INVENTION

1. Field of the Invention

The present invention relates to an image sensor, and more particularly, to a pixel array structure and a method of arranging the same capable of diagonally arranging pixels of a complementary metal-oxide-semiconductor (CMOS) image sensor in a lozenge pattern and disposing MOS pixel transistors between photodiodes of the pixels.

2. Description of the Related Art

An image sensor is a unit for converting an optical image into an electrical signal. In general, a charge coupled device (CCD) image sensor and a complementary metal-oxide-semiconductor (CMOS) image sensor are widely used.

In the CCD image sensor, MOS capacitors are disposed closely to each other, charge carriers are stored in the capacitors, and the stored charges are moved according to a gate signal.

In the CMOS image sensor, a switching method in which a control circuit and a signal processing circuit are used as peripheral circuits to combine photodiodes and MOS transistors according to the number of needed pixels so as to constitute a unit pixel, and by using the unit pixel outputs are sequentially detected, is used.

The CCD element has a problem in that an optical sensing unit and a signal processing unit are separately manufactured, but has a good resolution. Therefore, the CCD image sensor is widely used in a camcorder and a camera in science or medicine area.

The CMOS image sensor has an advantage in that a pixel array, a pixel driving unit, and a circuit for processing signals can be included in a single chip. Therefore, the CMOS image sensor is widely used in a personal computer (PC) camera which is popularized, a mobile phone camera, a toy, and a double mode camera.

As shown in FIG. 1, the unit pixel 100 of the CMOS image sensor may have a 3T structure including an optical sensing element represented by a photodiode D_{PD} and three MOS transistors M_{RX}, M_{SF}, and M_{SEL}, or as shown in FIG. 2, the unit pixel 200 of the CMOS image sensor may have a 4T structure including an optical sensing element DPD and four MOS transistors M_{TX}, M_{RX}, M_{SF}, and M_{SEL}.

Now, operations of the unit pixel which is a main component of the CMOS image sensor will be described with reference to FIG. 1.

A reset signal RX is input, all pixels stay in an initial state by the reset transistor M_{RX}. When the reset signal RX is turned off, a light signal condensed by a micro-lens (not shown) is converted into an electrical signal by the photodiode D_{PD}. According to a magnitude of the light signal, magnitudes of currents at both ends of the photodiode change. In addition, signals of pixels having different magnitudes are transmitted to an output line OUT by the source follower transistor M_{SF} and the selection transistor M_{SEL} that is operated by a proper selection signal SEL.

A conventional method of arraying unit pixels 100 and 200 of a CMOS image sensor is disclosed in Korean Patent Application No. 2002-0094607 (2002.12.18) as “A pixel array method of a CMOS image sensor”.

Now, for the convenience of description, the pixel array method according to the conventional invention is described in FIG. 3. Conventionally, as shown in FIG. 3, unit pixels 300 are disposed at positions where a row and a column cross.

Although not shown in the figure, when center points of adjacent four pixels are connected, a square having horizontal and vertical lines is shown.

FIG. 4 shows a schematic layout of pixels according to the conventional array method. Each unit pixel is constructed with an optical sensing element 10 represented by a photodiode and a MOS transistor circuit unit 20. Since the unit pixels have to be manufactured to be electrically separated from each other, the unit pixels are sequentially disposed at predetermined intervals. This interval is called a pitch. When the unit pixels are disposed at less than a predetermined pitch, a resolving power limit permitted in a manufacturing process is exceeded, so that an electric isolation between the unit pixels is impossible.

A row pitch Pr shown in FIG. 4 represents a distance from a pixel in a row to a pixel in the next row, that is, a unit distance between rows.

A column pitch Pc represents a distance from a pixel in a column to a pixel in the next column, that is, a unit distance between columns.

A distance dl represents a minimum distance between two optical sensing elements 10.

As shown in FIG. 4, a region ratio occupying the optical sensing element 10 is largest in each unit pixel. Therefore, a size of the optical sensing element 10 determines the pitches Pc and Pr between the unit pixels. As the size of the optical sensing element 10 increases, the pitches Pc and Pr also increase.

The pitches Pc and Pr and the distance d1 are determined by a micro manufacturing technology of manufacturing a semiconductor element. It is well known by those skilled in the art that when the manufacturing technology is determined, the pitches and distance are also determined as fixed values. It is also well known that when the unit pixel including the optical sensing elements 10 are manufactured to have the pitches Pc and Pr and the distance d1 less than the values determined in the manufacturing technology, electric and physical isolation between the elements cannot be maintained, and proper operations of the elements cannot be guaranteed.

A CMOS image sensor developer may want to increase the region of the optical sensing element 10 to increase a photo sensitivity and a resolution of the image sensor. However, due to the aforementioned problems, that is limited.

As described above, in the manufacturing process for the image sensor, in an effort to increase the photo sensitivity and the resolution of the image sensor, the layout of the pixels is designed to increase the region of the optical sensing element 10. However, the MOS transistor circuit unit 20 cannot be removed. Therefore, the MOS transistor circuit units 20 are disposed between the optical sensing elements 10. However, since the region is limited, the aforementioned effort is also restricted.

### SUMMARY OF THE INVENTION

The present invention provides an improved pixel array structure and method capable of increasing a photo sensitivity and a resolution of a complementary metal-oxide-semiconductor (CMOS) image sensor.

The present invention also provides a pixel array structure and method capable of increasing an effective region of an optical sensing element.

The present invention also provides an electronic device having a CMOS image sensor according to the present invention with a more improved performance.

According to an aspect of the present invention, there is provided a pixel array method of a complementary metal-oxide-semiconductor (CMOS) image sensor including steps of (a) forming a unit pixel array by arranging a plurality of unit pixels in a lozenge pattern with a plurality of rows and columns; (b) extending signal lines in a column direction at the plurality of the unit pixels to be connected to each of a plurality of unit column decoders in order to electrically operate the plurality of the unit pixels; and (c) extending signal lines in a row direction at the plurality of the unit pixels to be connected to each of a plurality of unit row decoders in order to electrically operate the plurality of the unit pixels, and arranging the signal lines in two rows to be connected to a single unit row decoder.

In the above aspect of the present invention, the step of forming the unit pixel array in a lozenge pattern may include a step of shifting a pixel array in a row to a half of a column pitch so that the pixel array in the row is not arranged at the same column position as that of a pixel array in the next row.

In addition, the step of arranging signal lines in a column direction at the plurality of the unit pixels in order to electrically operate the plurality of the unit pixels may include a step of connecting all signal lines including an additional output signal line and power source signal line for every unit pixel in a pixel array in a row to allow the signal lines to be connected in a column direction.

In addition, the step of arranging signal lines in a row direction at the plurality of the unit pixels in order to electrically operate the plurality of the unit pixels may include a step of connecting additional control signals included in every unit pixel such as a reset signal, a transfer signal, or a selection signal in a pixel array in a row to allow the control signals to be connected in a row direction.

According to another aspect of the present invention, there is provided a pixel array structure of a CMOS image sensor including: an array of unit pixels including a plurality of rows and columns in which unit pixels in a row are arranged diagonally to unit pixels in the next row; a plurality of unit row decoders arranged in a column direction of the unit pixels to allocate row direction addresses to the unit pixels; and a plurality of unit column decoders arranged in a row direction of the unit pixels to allocate column direction addresses to the unit pixels, wherein each of the unit row decoders simultaneously allocates row direction addresses to unit pixels in two rows.

According to another aspect of the present invention, there is provided a pixel array structure of a CMOS image sensor including: an array of unit pixels including a plurality of rows and columns in which unit pixels in a row are arranged to be shifted to a half of a column pitch in a row direction with respect to unit pixels in the next row; a plurality of unit row decoders arranged in a column direction of the unit pixels to allocate row direction addresses to the unit pixels; and a plurality of unit column decoders arranged in a row direction of the unit pixels to allocate column direction addresses to the unit pixels, wherein each of the unit row decoders simultaneously allocates row direction addresses to unit pixels in two rows.

### BRIEF DESCRIPTION OF THE DRAWINGS

FIG. 1 is a circuit diagram showing a pixel of a complementary metal-oxide-semiconductor (CMOS) image sensor constructed with a photodiode and three MOS transistors;

FIG. 2 is a circuit diagram showing a pixel of a CMOS image sensor constructed with a photodiode and four MOS transistors;

FIG. 3 shows an array structure of a conventional CMOS image sensor;

FIG. 4 is a schematic layout of a pixel array according to a related art;

FIG. 5 is a schematic layout of a pixel array according to an embodiment of the present invention;

FIG. 6 is a schematic layout for showing a pixel structure according to the present invention exemplifying a pixel with 4T structure;

FIG. 7 shows unit pixels shown in FIG. 4 which are sequentially arrayed.

FIG. 8 shows an array of pixels to show an entire pixel array structure according to the present invention;

FIG. 9 is a view showing a pixel array structure according to an embodiment of the present invention;

FIG. 10 is a view showing a unit row decoder included in a pixel array structure according to an embodiment of the present invention; and

FIG. 11 is a view showing a pixel array structure employing the unit row decoder shown in FIG. 10.

### DETAILED DESCRIPTION OF THE INVENTION

Hereinafter, exemplary embodiments of the present invention will be described in detail with reference to the attached drawings.

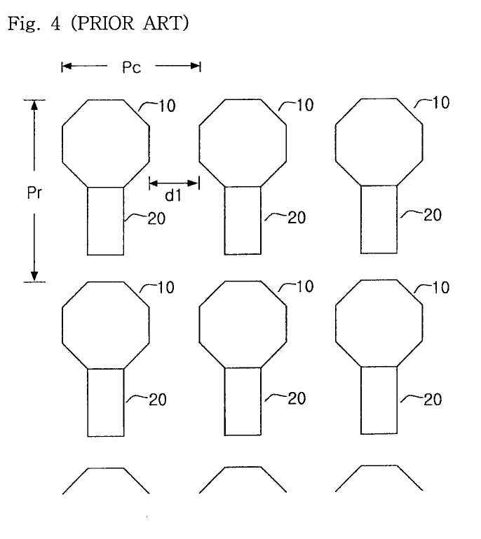

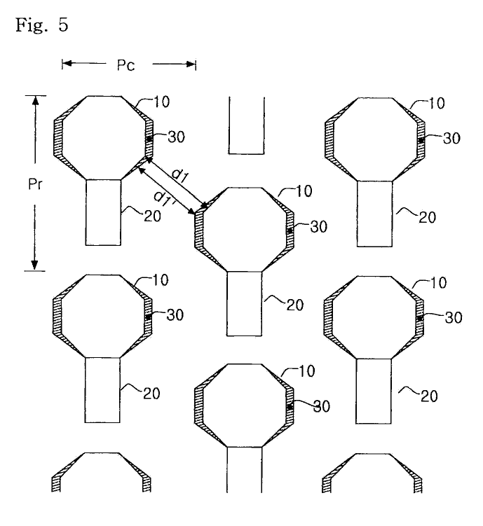

FIG. 5 shows a schematic layout of a pixel array according to an embodiment of the present invention. In order to compare the embodiment of the present invention to the method according to the related art, pixels in FIG. 5 are arranged at column pitches Pc and row pitches Pr similarly in FIG. 4. In addition, optical sensing units 10 and MOS transistor circuit units 20 are simplified similarly in FIG. 4.

Referring to FIG. 5, unit pixels are arranged in rows and columns. A unit pixel array in a row is disposed diagonally to a unit pixel array in the next row. In the arrangement method, although the pixels are arranged at the same column pitches Pc and row pitches Pr as in the conventional arrangement method, a distance d1 between two optical sensing units 10 is larger than a distance d1′ in the conventional arrangement method. This means that a region of the optical sensing unit 10 can be larger. Therefore, although the same manufacturing technology as that in the related art is used, the region of the optical sensing element 10 according to the present invention can be increased by a hatched region 30 so as to receive light sufficiently.

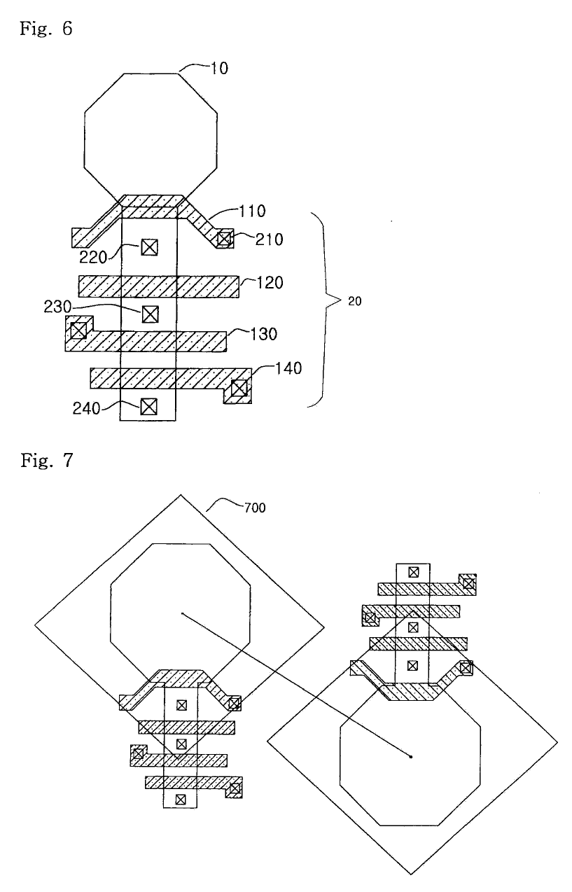

FIG. 6 is a schematic layout of a 4T pixel according to an embodiment of the present invention.

Now, the layout shown in FIG. 6 will be described with reference to the circuit diagram shown in FIG. 2.

The MOS transistor circuit unit 20 includes a transfer transistor M_{TX} 110, a reset transistor M_{RX} 120, a source follower transistor M_{SF} 130, and a selection transistor M_{SEL} 140. Since the operations of the circuit unit 20 are described above, detailed description is omitted. Contact portions 210 to 240 are connection portions that are electrically connected to connection lines such as power lines and selection lines for electrically operating the MOS transistor circuit unit 20 such that electric operations of the entire array can be properly performed.

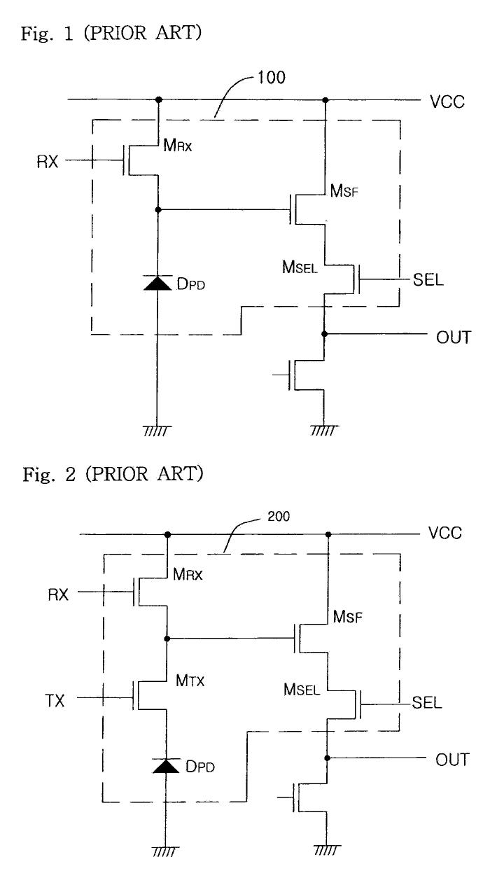

In the layout shown in FIG. 6, the 4T pixel is exemplified. However, it will be understood by those skilled in the art that the 3T pixel shown in FIG. 1 can be exemplified in the layout similarly in FIG. 5.

FIG. 7 is a view showing two 4T pixels which are arrayed in the method according to the present invention. The optical sensing element of the pixel with a color filter or a micro-lens 700 is shown.

According to the spirit and scope of the present invention, when center points of the two optical sensing units are connected, a diagonal line is apparently shown.

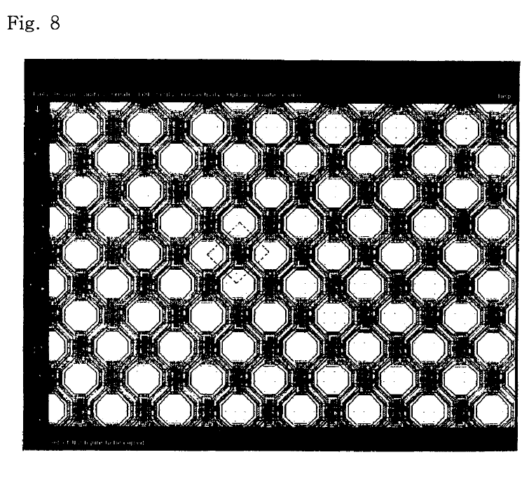

FIG. 8 shows an array of pixels according to method of the present invention. When center points of four adjacent optical sensing units are connected, the connected center points form a lozenge shape having four diagonal lines represented as dotted lines.

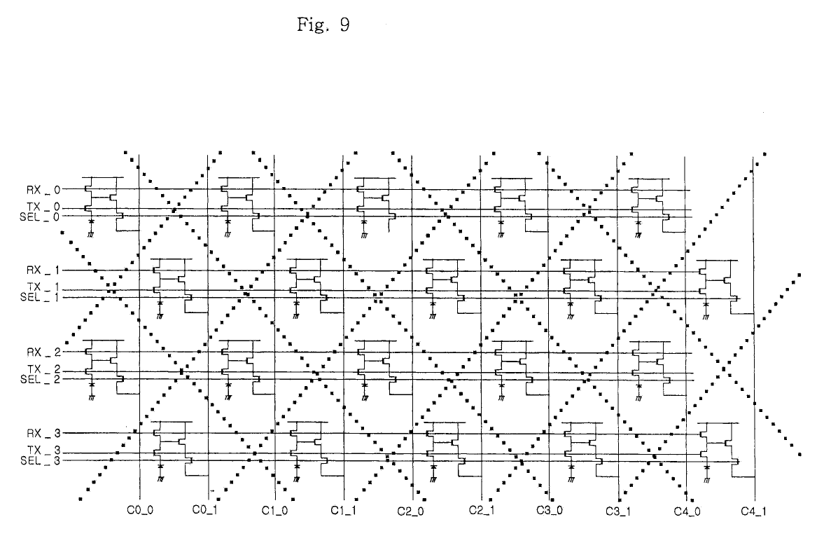

FIG. 9 is a view showing a pixel array structure according to an embodiment of the present invention. In FIG. 9, in order to easily represent the spirit and scope of the present invention, the pixels are divided by dotted lines. According to the division, a structure with a plurality of rows and columns forms lozenge shapes.

Signal lines in a row direction shown in FIG. 9 are lines RX_{—}0 to RX_{—}3 representing reset signals, lines TX_{—}0 to TX_{—}3 representing signals for transmitting signals that are obtained by converting light signals into electrical signals to other portions of the pixel, and lines SEL_{—}0 to SEL_{—}3 representing signals for selecting pixels to transmit electrical signals of pixels to the outside of the array.

In order to drive the pixel array by using the signal lines RX_{—}0, TX_{—}0, SEL_{—}0, and the like in the row direction and the signal lines C0_{—}0, C0_{—}1, C1_{—}0, and the like in the column direction, a row decoder (not shown) for driving the unit pixels in the row direction and a column decoder (not shown) for driving the unit pixels in the column direction are needed. Here, the row decoder forms an array including a plurality of the unit row decoders in the column direction, and the column decoder forms an array including a plurality of the unit row decoders in the row direction.

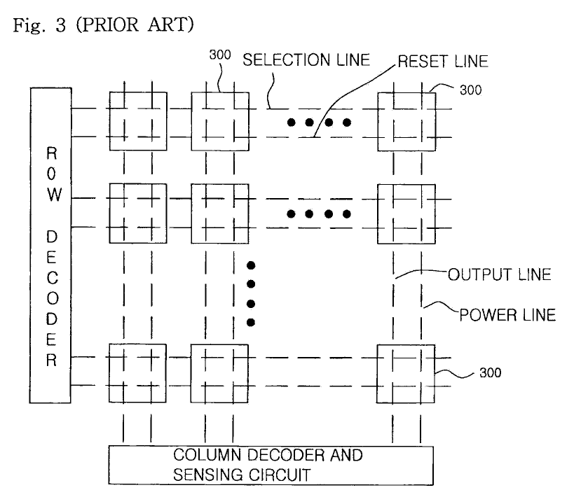

In a conventional pixel array structure arrayed in a rectangular type shown in FIGS. 2 and 3, a single unit row decoder is disposed for unit pixels of each row to form an array in the column direction, and a single unit column decoder is disposed for unit pixels of each column to form an array in the row direction. However, in the conventional pixel array structure, a column pitch Pc and a row pitch Pr are narrow, so that it is difficult to arrange each unit row decoder.

In the pixel array structure having a pixel array in a lozenge pattern as shown in FIG. 9 according to embodiment of the present invention, the number of unit pixels in two rows is the same as the number of unit pixels of a row in the conventional pixel array structure, however, a distance between rows is shorter than that in the conventional pixel array structure. This results in that more pixels can be integrated as compared with the conventional case when a given region is the same. Therefore, gaps between a plurality of pixels are improved as compared with the conventional case, and quality of a screen can be improved.

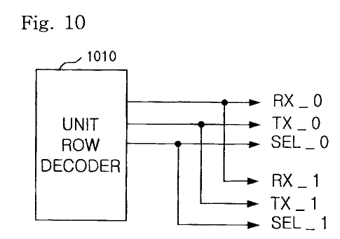

FIG. 10 is a view showing a unit row decoder included in a pixel array structure according to an embodiment of the present invention.

Referring to FIG. 10, the row decoder can simultaneously select a plurality of the pixels included in two rows. When a unit row decoder 1010 is arranged to simultaneously allocate row direction addresses to unit pixels in two rows, the unit pixels in the two rows can be simultaneously driven, so that a region of the unit row decoder 1010 can be enlarged as compared with the conventional case. In this case, a plurality of the pixels in adjacent two rows are not arranged in a longitudinal direction but arranged in a diagonal direction, so that quality of a screen is not deteriorated although two adjacent rows are simultaneously selected. On the contrary, in the conventional pixel array structure having a rectangular structure, when two adjacent rows are simultaneously selected, the quality of the screen is deteriorated.

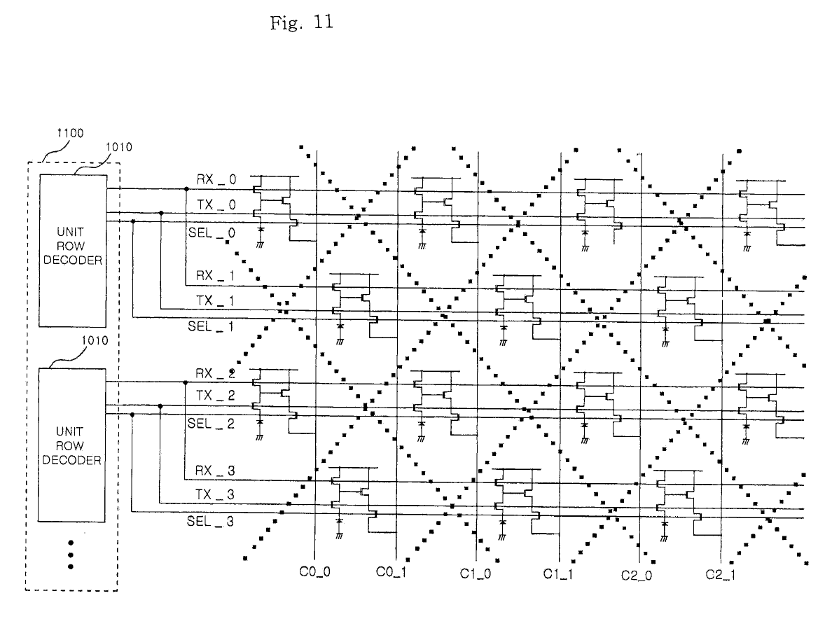

FIG. 11 is a view showing a pixel array structure employing the unit row decoder 1010 shown in FIG. 10.

Referring to FIG. 11, the unit row decoder 1010 included in a row decoder 1100 can simultaneously drive pixels in two rows, so that a region occupied by each unit row decoder 1010 can be relatively enlarged while the unit row decoder 1010 drives unit pixels having the same number as that of unit pixels allocated to the conventional unit row decoder in the row direction.

According to the scope and spirit of the present invention, a region increase efficiency of the optical sensing unit is increased by substantially 30% to 40%.

Accordingly, the light sensitivity and the resolution are increased by substantially 30% to 40%.

While the present invention has been particularly shown and described with reference to exemplary embodiments thereof, it will be understood by those skilled in the art that various changes in form and details may be made therein without departing from the spirit and scope of the present invention as defined by the appended claims.

According to the present invention, a pixel array is implemented in a lozenge pattern, and a transistor circuit of a pixel is arranged between optical sensing elements. Therefore, an effective region of an optical sensing element is increased, so that light sensitivity and a resolution increase.

According to another aspect of the present invention, all circuits are integrated in a single substrate, so that a CMOS image sensor can be implemented in a single chip.

What is claimed is:

1. A method of arraying pixels of a CMOS (complementary metal-oxide-semiconductor) image sensor constructed with an optical sensing element and MOS transistors, the method comprising steps of:
(a) forming a unit pixel array by arranging a plurality of unit pixels in a lozenge pattern with a plurality of rows and columns;
(b) extending signal lines in a column direction at the plurality of the unit pixels to be connected to each of a plurality of unit column decoders in order to electrically operate the plurality of the unit pixels; and
(c) extending signal lines in a row direction at the plurality of the unit pixels to be connected to each of a plurality of unit row decoders in order to electrically operate the plurality of the unit pixels, and arranging the signal lines in two rows to be connected to a single unit row decoder.

2. The method of claim 2, wherein the signal lines in the step (b) are column output signal lines or power source signal lines of each unit pixel.

3. The method of claim 1, wherein the signal lines in the step (c) are row selection signals lines or reset signal lines of each unit pixel.

4. A sequential array structure of pixels of a CMOS image sensor constructed with an optical sensing element and MOS transistors, the structure comprising:
an array of unit pixels including a plurality of rows and columns in which unit pixels in a row are arranged diagonally to unit pixels in the next row;
a plurality of unit row decoders arranged in a column direction of the unit pixels to allocate row direction addresses to the unit pixels; and
a plurality of unit column decoders arranged in a row direction of the unit pixels to allocate column direction addresses to the unit pixels,
wherein each of the unit row decoders simultaneously allocates row direction addresses to unit pixels in two rows.

5. A sequential array structure of pixels of a CMOS image sensor constructed with an optical sensing element and MOS transistors, the structure comprising:
an array of unit pixels including a plurality of rows and columns in which unit pixels in a row are arranged to be shifted to a half of a column pitch in a row direction with respect to unit pixels in the next row;
a plurality of unit row decoders arranged in a column direction of the unit pixels to allocate row direction addresses to the unit pixels; and
a plurality of unit column decoders arranged in a row direction of the unit pixels to allocate column direction addresses to the unit pixels,
wherein each of the unit row decoders simultaneously allocates row direction addresses to unit pixels in two rows.
